(19) United States
(12) Patent Application Publication
(10) Pub. No.: US 2021/0056957 A1
(43) Pub. Date: Feb. 25, 2021

(54) Ability Classification

(71) Applicant: CP CONNECTIONS LIMITED, Glasgow, Strathclyde (GB)

(72) Inventors: Edward DOCHERTY, Glasgow (GB); Marie GRIEVE, Glasgow (GB)

(73) Assignee: CP Connections Limited, Glasgow, Strathclyde (GB)

(21) Appl. No.: 16/978,381

(22) PCT Filed: Mar. 1, 2019
(86) PCT No.: PCT/GB2019/050572

§ 371 Date: Sep. 4, 2020

(30) Foreign Application Priority Data
Mar. 4, 2018 (GB) 1803464.5

(51) Int. Cl. G10L 15/16; G10L 25/30; G10L 25/51; G06N 3/08

(52) U.S. Cl. CPC G10L 15/16; G06N 3/084; G10L 25/51; G10L 25/30

(57) ABSTRACT

A system for classifying a subject's ability, said system comprising at least one user device adapted to present information on an interface to prompt a subject to provide user data associated with a predetermined ability and to capture the user data; and a first server adapted to receive the user data and input the user data into at least one artificial neural network, wherein

the artificial neural network is trained to convert user data associated with the predetermined ability of the subject into one or more classification scores indicative of the predetermined ability of the subject.

### TECHNICAL FIELD

The present invention relates to systems and methods for classifying a predetermined ability of a subject. For example, in certain embodiments of the invention, systems and methods are provided for classifying a subject's ability to read.

### BACKGROUND

Conventional techniques for systematically assessing a subject's (such as a child's) ability in a particular area, for example in reading, mathematics, geography or history, involves a human teacher interacting with the child and then providing feedback based on the teacher's assessment of the child's ability.

Necessarily, this technique requires a teacher to spend time interacting with the child. In a typical school environment there may normally be 20 to 30 children per teacher. Therefore, the amount of time a teacher can devote to a particular child is typically limited.

At present there are few alternatives techniques that enable a subject's ability in a particular area to be systematically assessed without the presence of a teacher.

### SUMMARY OF THE INVENTION

In accordance with a first aspect of the invention, there is provided a system for classifying a subject's ability. The system comprises at least one user device adapted to present information on an interface to prompt a subject to provide user data associated with a predetermined ability and to capture the user data. The system further comprises a first server adapted to receive the user data and input the user data into at least one artificial neural network. The artificial neural network is trained to convert the user data associated with the predetermined ability of the subject into one or more classification scores indicative of the predetermined ability of the subject.

Optionally, the system is adapted to classify a subject's reading ability, wherein the information presented on the interface of the user device is text to be read by a subject, and the user device is adapted to capture audio data of the subject reading the text. The system comprises a further server adapted to receive the audio data from the user device and to convert the audio data into transcription data. The further server is adapted to communicate the transcription data to the first server which is adapted to receive the transcription data and input the transcription data into the at least one artificial neural network. The artificial neural network is trained to convert transcription data associated with the text into one or more classification scores indicative of the subject's ability to read.

Optionally, the first server is adapted to generate classification result data comprising classification scores generated by the artificial neural network from input transcription data generated from the audio data, wherein the user device is adapted to receive the classification result data and display it on the interface.

Optionally, the system further comprises a third server adapted to receive audio data from the user device and to communicate it to the further server.

Optionally, the third server is adapted to receive the transcription data from the further server and communicate it to the first server.

Optionally, the third server is adapted to receive classification result data from the first server and to communicate it to a report generating server, receive a report data comprising the result data from the report generating server and communicate the report data to the user device.

Optionally, the user device is a smart phone or tablet.

Optionally, the text is selectable on the user device.

Optionally, the transcription data is text data.

In accordance with a second aspect of the invention, there is provided a method comprising presenting information on a user device interface to prompt a subject to provide user data associated with a predetermined ability of the subject; capturing the user data; and receiving at a first server the user data and inputting the user data into at least one artificial neural network. The artificial neural network is trained to convert the user data associated with the ability of the subject into one or more classification scores indicative of the predetermined ability of the subject.

Optionally, the information presented on the interface of the user device is text to be read by a subject, and the user data is audio data of the subject reading the text. The method further comprises receiving the audio data at a further server and converting the audio data into transcription data; communicating by the further server the transcription data to the first server which is adapted to receive the transcription data and input the transcription data into the at least one artificial neural network, and converting the transcription data into one or more classification scores indicative of the subject's ability to read.

Optionally, the method further comprises generating classification result data comprising classification scores generated by the artificial neural network from input transcription data generated from the audio data, and displaying the classification result data and on the interface.

Optionally, the method further comprises receiving audio data from the user device and communicating it to the further server using a third server.

Optionally, the method further comprises receiving the transcription data from the further server and communicating it to the first server using the third server.

Optionally, the method further comprises, by the third server, receiving classification result data from the first server and communicating the classification result data to a report generating server; receiving report data comprising the result data from the report generating server and communication the report data to the user device.

Optionally, the user device is a smart phone or tablet.

Optionally, the text is selectable on the user device.

Optionally, the transcription data is text data.

In accordance with a third aspect of the invention, there is provided a system for classifying a subject's reading ability. The system comprises at least one user device adapted to present a text on an interface to be read by a subject and to capture audio data of the subject reading the text; a first server adapted to receive the audio data and to convert the audio data into transcription data; and a second server adapted to receive the transcription data and input the transcription data into at least one artificial neural network. The artificial neural network is trained to convert transcription data associated with the text into one or more classification scores indicative of the subject's ability to read.

In accordance with a fourth aspect of the invention, there is provided a method of classifying a subject's reading ability. The method comprises: presenting text on an interface to be read by a subject; capturing audio data of the subject reading the text; receiving at a first server the audio data and converting the audio data into transcription data; and receiving at a second server the transcription data and inputting the transcription data into at least one artificial neural network. The artificial neural network is trained to convert transcription data associated with the text into one or more classification scores indicative of the subject's ability to read.

In accordance with a fifth aspect of the invention, there is provided a method of classifying a subject's ability. The method comprises presenting information on a user device interface to prompt a subject to provide user data associated with a predetermined ability of the subject; capturing the user data; and communicating the user data to a first server which is arranged to input the user data into at least one artificial neural network. The artificial neural network is trained to convert the user data associated with the ability of the subject into one or more classification scores indicative of the predetermined ability of the subject.

In accordance with a sixth aspect of the invention, there is provided a computer program comprising computer executable instructions, which when implemented on a computer causes the computer to perform a method according to the fourth aspect.

In accordance with a seventh aspect of the invention, there is provided a computer program product having stored thereon computer implementable instructions in accordance with the computer program according to the fifth aspect.

In accordance with certain aspects of the invention, a system is provided that allows systematic assessment of subject's ability without need for human intervention, e.g. supervision by teacher. In certain embodiments, software (delivered by a bespoke software program) running on a user device provides a “learning aid”.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a schematic diagram of a system in accordance with an example of the invention,

FIG. 2 provides a flow chart depicting a method of classifying a subject's reading ability using a system as depicted in FIG. 1, and

FIG. 3 provides a schematic diagram of a system in accordance with certain embodiments of the invention.

### DETAILED DESCRIPTION

The ability of a subject, for example a child, to perform a learned skill such as reading, or to demonstrate knowledge of a learned subject such as mathematics, geography or history can be classified in accordance with various classification metrics.

For example, for the learned skill of reading, a first classification can be the accuracy with which a subject can read out loud, with correct pronunciation, regular (common) words, that is words that appear in the relevant language (e.g. English) with a frequency above a threshold amount.

A second classification can be the accuracy with which a subject can read out loud, with correct pronunciation, irregular (uncommon) words, that is words that appear in the relevant language (e.g. English) with a frequency below a threshold amount.

A third classification can be fluency, that is the speed at which a subject can read a piece of text with an accuracy above a threshold level of accuracy.

In accordance with certain embodiments of the invention, a system is provided for generating classification information associated with a subject's reading ability.

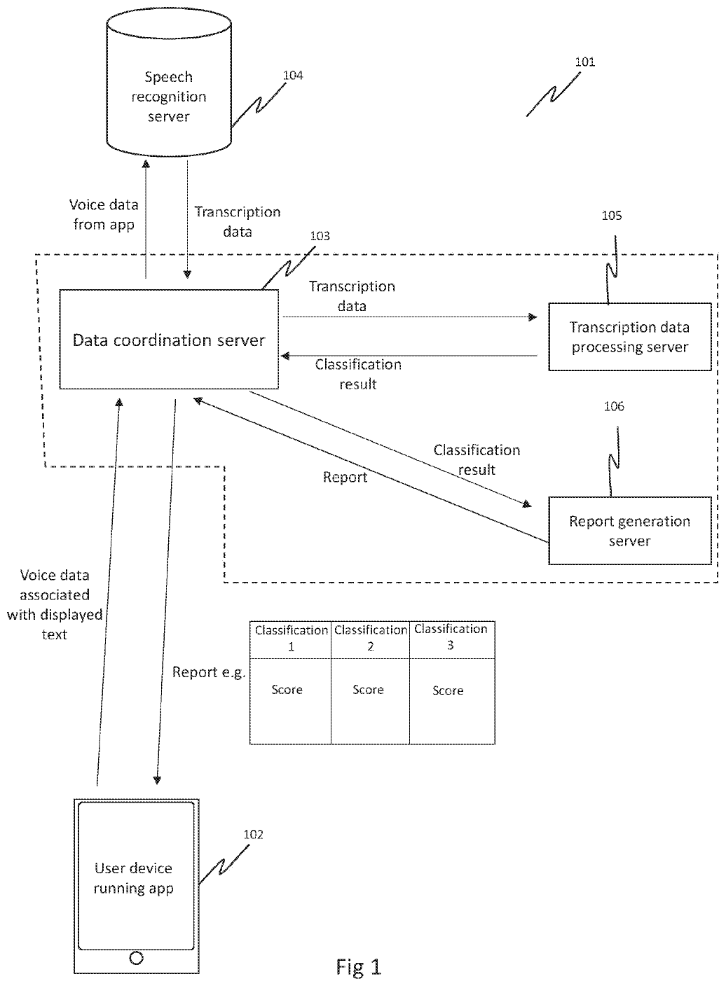

FIG. 1 provides a schematic diagram of a system 101 in accordance with an example of the invention.

The system 101 includes a user device 102, such as a smartphone or tablet, that has running thereon an “app” (e.g. a computer program downloaded from an “app store” running on a remote server). The app is arranged to control the user device to display on a display of the user device a reading interface which displays text to be read by a subject. Further, the app controls the user device 102 to record speech of the subject as they are reading the text. This is achieved, for example, by displaying a “read text now” graphic whilst simultaneously recording speech by a subject using a microphone device incorporated into the user device (as is known in the art) and storing this in memory.

Once the voice data has been captured and stored in memory, the app controls the user device 102 to communicate the voice data to a data co-ordination server 103. The data co-ordination server 103 has running thereon software for coordinating the transmission of data within the system as will be described below.

Typically, the voice data is communicated from the user device 102 to the data co-ordination server 103 using conventional data transmission techniques. For example, the user device may include an 802.11 (e.g. “Wi-Fi”) radio transceiver which allows data to be communicated to and from a wireless LAN access point, which provides onward access to an IP network (e.g. the internet). The data coordination server 103 is similarly connected to the IP network (e.g. the internet) via a suitable network connection allowing IP data to be communicated between the user device 102 and the data coordination server 103.

The data coordination server 103 can communicate data to and from a speech recognition server 104 via a suitable network connection. The speech recognition server 104 can be provided by a third party.

On receipt of the voice data, the data coordination server 103 is arranged to communicate the voice data to a speech recognition server 104. The speech recognition server 104 has running thereon speech recognition software which is adapted to convert audio data of a subject speaking (e.g. the voice data captured by the app on the user device 102) into a format for further processing. For example, in certain embodiments, on receipt of the voice data, the speech recognition server 104 is adapted to run the speech recognition software and generate transcription data corresponding to the recognised speech. This transcription data, typically text data, is communicated back to the data coordination server 103.

The data coordination server 103 is arranged to then communicate the transcription data to a transcription data processing server 105. The data coordination server 103 may provide other information with the transcription data, for example, time data indicative the length of the voice data (which is indicative of how long it took the subject to read the displayed text) and other information about the subject, for example their age.

Typically, the transcription data processing server 105 has running thereon an artificial neural network which has been trained to convert transcription data relating to a specific text (i.e. the text that the subject read to generate the voice data) into scores associated with specific reading classifications, such as accuracy of common word pronunciation, accuracy of uncommon word pronunciation and fluency.

On receipt of the transcription data, the transcription data processing server 105 converts the transcription data into a format for input to the artificial neural network. This formatted data is then input to the artificial neural network which then outputs classification result data, for example in the format of a number of scores, where each score corresponds to a score associated with a specific classification type. After the generation of the classification result data, the transcription data processing server 105 is adapted to communicate the classification result data to the data coordination server 103. On receipt of the classification result data, the data coordination server 103 is adapted to communicate the classification result data to a report generation server 106.

The report generation server 106 has software running thereon which is adapted to convert the classification result data generated by the transcription data processing server 105 into report data.

The report data provides a report in which the classification result data is inserted. The report data may include ancillary information, for example guidance information for parents, selected from a library of ancillary information. The ancillary information may be selected based on the classification result data. For example, if the classification result data indicates that a subject is struggling with a particular aspect of reading, ancillary information may be selected and included in the report which provides guidance on how to improve that aspect of the subject's reading.

On generation of the report data, the report generation server 106 is adapted to communicate the report data to the data coordination server 103. On the receipt of the report data, the data coordination server 103 is adapted to communicate the report data to the user device 102. The report data can then be viewed, for example via a suitable interface provided by the app, on the user device 102.

The provision of report data, generated in this way, that can be viewed on a user device can provide motivation to certain subjects, for example children, to engage in reading. Children, familiar with attempting to achieve a high score with computer games, may be motivated to achieve high scores associated with their reading ability. Further, people associated with the subject, for example a subject's parents, are provided with systematic, quantified information relating to the subject's ability to read without the need to rely on feedback from a teacher.

Typically, in use, the data coordination server 103 is arranged to communicate data to and from multiple user devices running versions of the app.

To enable this, when a user device first runs the app, the software running on the data coordination server 103 may be adapted to enable a user of the user device (for example a subject's parents) to create a “user account” using techniques known in the art, enabling the data coordination server to identify and store information related to, for example, the subject, such as name, age, gender and other relevant information.

As mentioned above, typically, the transcription data processing server 105 has running thereon an artificial neural network trained to convert transcription data into scores associated with specific reading classifications.

Any suitable artificial neural network and any corresponding suitable training process can be undertaken to achieve this.

In one example, a simple feedforward network is used. The input to the artificial neural network is the transcription data and the out of the artificial neural network is a number of numerical values, each numerical value associated with a reading classification score.

Training data is provided. The training data includes multiple pieces of transcription data. Each piece of transcription data corresponds to a transcription of a different user reading a predetermined passage of text. Further, each piece of transcription data has associated with it scores associated with the different reading classifications. The training data can be prepared in any suitable way. In one example, an expert, for example a teacher, listens to audio of a subject reading and classifies the reading in accordance with the numerical reading classification scores.

During a training phase, transcription data is input to the network undergoing the training which generates classification scores. The classification scores generated by the network in this way are then compared to the classification scores associated with the training data (e.g. produced by the expert) to generate an error value. Artificial neural network training techniques (e.g. back propagation) can then be used to adjust the variables of the network to reduce the error value. This training process is then repeated for a number of training cycles to train the network to classify input transcription data into reading classification scores.

As will be appreciated, modifications to the arrangement can be made. For example, in certain embodiments, the transcription data processing server 105 may run a number of artificial neural networks in parallel, where each artificial neural network is arranged to output a single numerical value associated with a particular reading classification. In other words, a number of artificial neural networks are provided, where each artificial neural network is associated with a particular reading classification.

In other embodiments, more complex artificial neural networks can be used such as convolutional neural networks or recurrent neural networks which are structurally optimised for classifying transcription data associated with a subject reading text.

Typically, the artificial neural network or artificial neural networks described above will be trained to generate reading classification scores based on a particular predetermined text. In other words, the training data will relate to transcriptions of the same text read by multiple different subjects.

However, in accordance with certain examples, the app running on the user device enables a user to select multiple different texts for a subject to read. Thus, the transcription data communicated from the data coordination server 103 to the transcription data processing server 105 can be generated from audio data of users reading one of a number of different texts. Accordingly, in certain examples, the transcription data processing server 105 comprises a trained artificial neural network for generating classification result data for each different text. In other words, each artificial neural network is trained to generate classification result data for a specific text.

In other examples, the transcription data processing server 105 comprises an artificial neural network which is trained on transcription data from multiple different texts and therefore can be used for generating classification result data for transcription data associated with audio data of users reading different texts rather than one specific text.

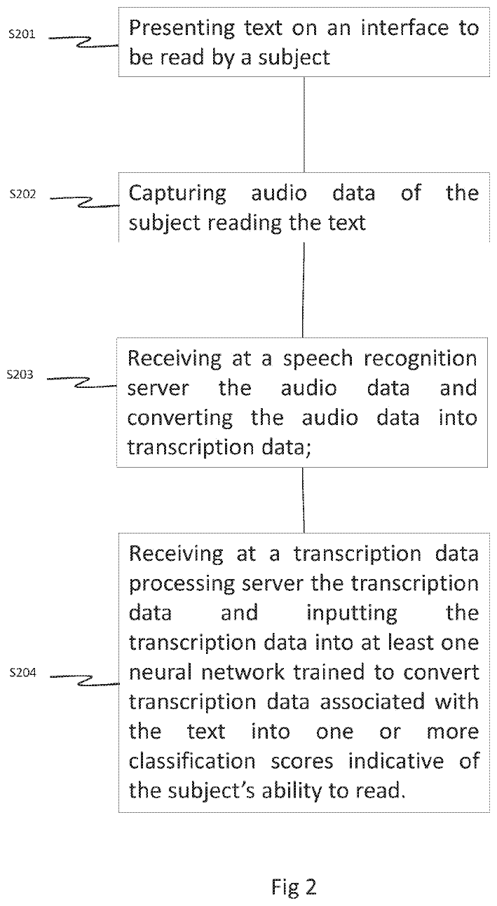

FIG. 2 shows a flow chart depicting a method of classifying a subject's reading ability using a system as depicted in FIG. 1.

At a first step S201 text is presented on an interface of a user device to be read by a subject; at a second step S202 audio data of the subject reading the text is captured by the user device; at a third step S203 the audio data is received from the user device at a speech recognition server and converted into transcription data; and at a fourth step S204, the transcription data is received at a transcription data processing server and input to an artificial neural network trained to convert the transcription data associated with the text into one or more classification scores indicative of the subject's ability to read.

Various modifications to the embodiments of the invention described above are envisaged.

In the example embodiments described above, the servers (the data co-ordination server, the speech recognition server and the transcription data processing server) are described as separate computing elements. Typically, these computing elements may be individual, physically distinct server devices, comprising one or more processors, memory, software for controlling the server device and suitable network communication hardware.

However, in certain embodiments, the system components of the systems described above, such as the data co-ordination server, the speech recognition server and the transcription data processing server are logical designations and may be manifested in alternative ways, for example on a single computing device or across several physical units using known distributed computing techniques. In some embodiments, the speech recognition server is provided by a third party and is accessed via a suitable API using techniques known in the art.

Software (a computer program or computer programs) for implementing aspects of the system on a suitable arranged computing device can be stored on any suitable computer program product such as a floppy disk, CD ROM, solid state memory storage device and so on.

In certain embodiments, systems are provided which classify a subject's ability in areas other than reading. For example, systems can be provided which classify a subject's ability in a particular academic subject such as mathematics, geography or history.

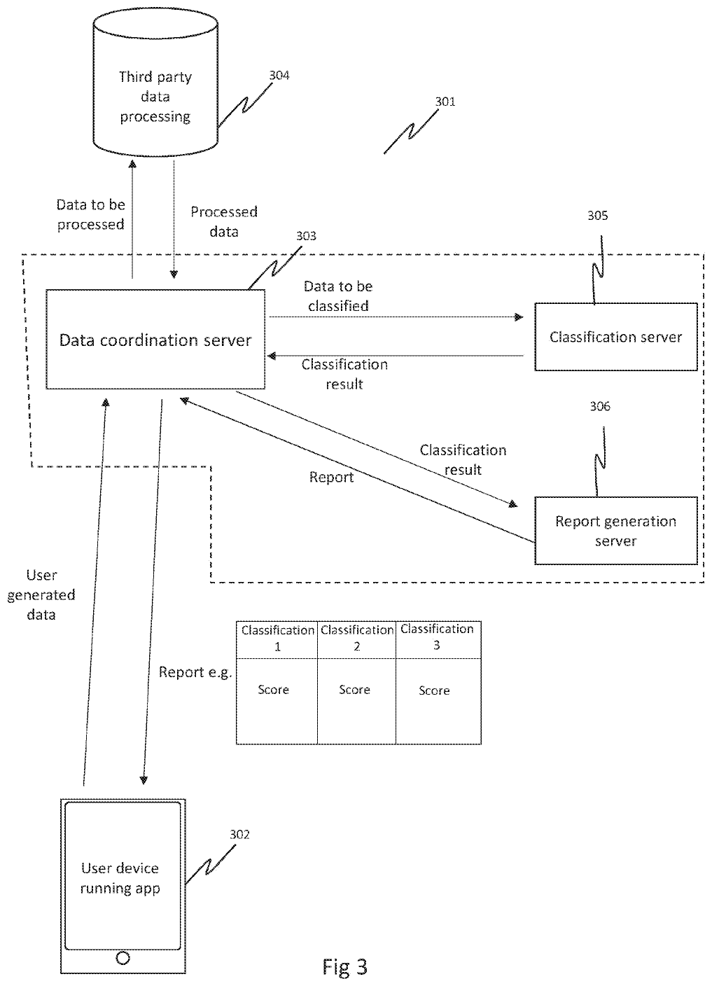

The structure and operation of such systems substantially correspond to the system shown in FIG. 1. An example of this is shown in FIG. 3.

In keeping with the system described with reference to FIG. 1, the system 301 shown in FIG. 3 includes a user device 302, such as a smartphone or tablet, that has running thereon an “app” arranged to control the user device 302 to display on a display of the user device an interface which displays information prompting a user to input data. The interface may prompt a user to provide an answer to a question relating to a particular subject. The answer may be provided in any appropriate way, for example by inputting text (for example via text entry means such as a keypad), selecting an answer from a number of displayed answers or answering the question verbally and using the user device to record the response. In any case, user data is generated corresponding to a user answer and this is captured and stored by the user device 302.

Once the user data has been captured and stored in memory, the app controls the user device 302 to communicate it to a data co-ordination server 303. The data co-ordination server 303 has running thereon software for coordinating the transmission of data within the system as will be described below.

In certain embodiments, the data coordination server 303 can communicate data to a third party data processing server 304.

For example, in certain embodiments in which the user data includes voice data, the data coordination server 303 is arranged to communicate the user data to a third party data processing server 304 which is adapted to convert the voice data from the user data into processed data comprising transcription data in keeping with the operation of the speech recognition server described above.

The data coordination server 303 is adapted to communicate the user data (including any data processed by a third party data processing server if provided) to a classification server 305. The data coordination server may provide other information with the user data, for example, information about the subject such as their age.

Typically, the classification server 305 has running thereon an artificial neural network which has been trained to convert user data relating into scores associated with specific classifications.

On receipt of the user data, the classification server 305 converts the user data into a format for input to the artificial neural network. This formatted data is then input to the artificial neural network which then outputs classification result data, for example in the format of a number of scores, where each score corresponds to a score associated with a specific type of classification related to the user's ability in the relevant area. After the generation of the classification result data, the classification server 305 is adapted to communicate the classification result data to the data coordination server 303. On receipt of the classification result data, the data coordination server 303 is adapted to communicate the classification result data to a report generation server 306 which is adapted to convert the classification result data generated by the transcription data processing server 305 into report data.

The report data provides a report in which the classification result data is inserted which can then be communicated back to the user device 302 as described above with reference to FIG. 1.

The system described with reference to FIG. 3 can be used to classify a subject's ability in many areas. In one example, the app displays on the user device 302 a number of questions relating to the academic subject of geography. Such questions can include questions about the demographics of particular countries, questions requiring a user to with which country a particular flag is associated and to identify a country based on an image of its geographical outline. The user's responses to these questions are communicated to the data co-ordination server 303 and processed by the classification server 305 as described above and report data is generated and sent back to the user device providing a number of classification scores. In the example of the subject of geography, a first classification score might relate to knowledge of the country demographics, a second classification score might relate to flag identification ability and a third classification score might relate to country recognition ability. As will be understood a subject's ability in many other areas, for example history or mathematics, can be classified in this way.

In the embodiments above, the user device has been described mainly in terms of a smartphone or tablet. However, other user devices can be used such as suitably network connected personal computers (such as laptops), games consoles, smart televisions and so on.

In the embodiments described above, the software running on the user device has been described as an “app”. As will be understood by the skilled person, “app” is a term used to describe a computer program running on a user device such as a smartphone or tablet computer. Typically, such computer programs are downloaded from a remote server (e.g. an “app store”). It will be understood that software running on user devices in accordance with embodiments of the invention can be provided by any suitable type of software, such as software acquired via physical media (a computer program product) such as, for example, a solid-state memory card or CD-ROM etc, and read from a memory drive of the user device (e.g. memory card drive or CD ROM drive). In certain embodiments, rather than an app, functionality running on the user device (e.g. the displaying information to prompt a user to provide user data and capturing the user data for communication to the data coordination server) is provided by web browser software running on the user device. The web browser software accesses a web server which hosts software downloaded to the web browser that allows the functionality described above to be performed on the user device.

In certain embodiments, the software running on the user device, be that as an “app” downloaded from an app store, software loaded from physical media or run via a web-browser can be considered a “learning aid” delivered by a bespoke software program.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

It will be appreciated that features from one embodiment may be appropriately incorporated into another embodiment unless technically unfeasible to do so.

It will be appreciated that various embodiments of the present disclosure have been described herein for purposes of illustration, and that various modifications may be made. Accordingly, the various embodiments disclosed herein are not intended to be limiting, with the scope being indicated by the following claims.

1. A system for classifying a subject's ability, said system comprising
at least one user device adapted to present information on an interface to prompt a subject to provide user data associated with a predetermined ability and to capture the user data; and
a first server adapted to receive the user data and input the user data into at least one artificial neural network, wherein
the artificial neural network is trained to convert the user data associated with the predetermined ability of the subject into one or more classification scores indicative of the predetermined ability of the subject.

2. A system according to claim 1, wherein the system is adapted to classify a subject's reading ability, wherein the information presented on the interface of the user device is text to be read by a subject, and the user device is adapted to capture audio data of the subject reading the text; wherein the system comprises a further server adapted to receive the audio data from the user device and to convert the audio data into transcription data; and
the further server is adapted to communicate the transcription data to the first server which is adapted to receive the transcription data and input the transcription data into the at least one artificial neural network, wherein
the artificial neural network is trained to convert transcription data associated with the text into one or more classification scores indicative of the subject's ability to read.

3. A system according to claim 2, wherein the first server is adapted to generate classification result data comprising classification scores generated by the artificial neural network from input transcription data generated from the audio data, wherein the user device is adapted to receive the classification result data and display it on the interface.

4. A system according to claim 3, further comprising a third server adapted to receive audio data from the user device and to communicate it to the further server.

5. A system according to claim 4, wherein the third server is adapted to receive the transcription data from the further server and communicate it to the first server.

6. A system according to claim 5, wherein the third server is adapted to receive classification result data from the first server and to communicate it to a report generating server, receive a report data comprising the result data from the report generating server and communicate the report data to the user device.

7. A system according to any previous claim, wherein the user device is a smart phone or tablet.

8. A system according to any previous claim, wherein the text is selectable on the user device.

9. A system according to any previous claim, wherein the transcription data is text data.

10. A method of classifying a subject's ability, said method comprising
presenting information on a user device interface to prompt a subject to provide user data associated with a predetermined ability of the subject
capturing the user data; and
receiving at a first server the user data and inputting the user data into at least one artificial neural network, wherein
the artificial neural network is trained to convert the user data associated with the ability of the subject into one or more classification scores indicative of the predetermined ability of the subject.

11. A method according to claim 10, wherein the information presented on the interface of the user device is text to be read by a subject, and the user data is audio data of the subject reading the text; said method further comprising
receiving the audio data at a further server and converting the audio data into transcription data;
communicating by the further server the transcription data to the first server which is adapted to receive the transcription data and input the transcription data into the at least one artificial neural network, and
converting the transcription data into one or more classification scores indicative of the subject's ability to read.

12. A method according to claim 11, comprising generating classification result data comprising classification scores generated by the artificial neural network from input transcription data generated from the audio data, and
displaying the classification result data and on the interface.

13. A method according to claim 12, comprising
receiving audio data from the user device and communicating it to the further server using a third server.

14. A method according to claim 13, comprising receiving the transcription data from the further server and communicating it to the first server using the third server.

15. A method according to claim 14, comprising, by the third server,
receiving classification result data from the first server and communicating the classification result data to a report generating server;
receiving report data comprising the result data from the report generating server and communication the report data to the user device.

16. A method according to any previous claim, wherein the user device is a smart phone or tablet.

17. A method according to claim 11, wherein the text is selectable on the user device.

18. A method according to any of claims 10 to 17, wherein the transcription data is text data.

19. A method of classifying a subject's ability, said method comprising
presenting information on a user device interface to prompt a subject to provide user data associated with a predetermined ability of the subject
capturing the user data; and
communicating the user data to a first server arranged to input the user data into at least one artificial neural network, and
the artificial neural network is trained to convert the user data associated with the ability of the subject into one or more classification scores indicative of the predetermined ability of the subject.

20. A computer program comprising computer executable instructions, which when implemented on a computer causes the computer to perform a method according to claim 19.

21. A computer program product having stored thereon computer implementable instructions in accordance with the computer program according to claim 20.
